(19) United States
(12) Patent Application Publication
(10) Pub. No.: US 2025/0123614 A1
(43) Pub. Date: Apr. 17, 2025

(54) POLYMER MELT POOL CRYSTALLIZATION MEASUREMENTS

(71) Applicants: HEWLETT-PACKARD DEVELOPMENT COMPANY, L.P., Spring, TX (US); NANYANG TECHNOLOGICAL UNIVERSITY, Singapore (SG)

(72) Inventors: Van Thai TRAN, Singapore (SG); Hejun DU, Singapore (SG); Jun ZENG, Palo Alto, CA (US); Kun ZHOU, Singapore (SG); How Wei Benjamin TEO, Singapore (SG); Kaijuan CHEN, Singapore (SG); Kim Quy LE, Singapore (SG)

(73) Assignees: HEWLETT-PACKARD DEVELOPMENT COMPANY, L.P., Spring, TX (US); NANYANG TECHNOLOGICAL UNIVERSITY, Singapore (SG)

(21) Appl. No.: 18/684,472

(22) PCT Filed: Aug. 16, 2021
(86) PCT No.: PCT/US2021/046088

§ 371 Date: Feb. 16, 2024

(51) Int. Cl. G05B 19/4155; G06T 7/00; G06T 7/60

(52) U.S. Cl. CPC G05B 19/4155; G06T 7/0002; G06T 7/60; G05B 2219/50333

(57) ABSTRACT

In one example in accordance with the present disclosure, an electronic device is described. An example electronic device includes a processor and memory storing executable instructions that when executed cause the processor to receive an image of a polymer melt pool captured during crystallization of the polymer melt pool. The instructions also cause the processor to measure brightness of the polymer melt pool in the captured image. The instructions further cause the processor to determine crystallization information of the polymer melt pool based on the measured brightness of the polymer melt pool.

### BACKGROUND

Electronic technology has advanced to become virtually ubiquitous in society and has been used to enhance many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to measure polymer melt pool crystallization information, according to an example.

FIG. 2A illustrates nucleation of a polymer melt pool, according to an example.

FIG. 2B illustrates crystal spherulite growth in a polymer melt pool, according to an example.

FIG. 3 is a graph of measured pixel brightness in an image plotted over time, according to an example.

FIG. 4 illustrates determining crystallization information for a plurality of regions of a polymer melt pool, according to an example.

FIG. 5 is a flow diagram illustrating a method for measuring polymer melt pool crystallization, according to an example.

FIG. 6 illustrates a system to measure crystallization of a polymer melt pool, according to an example.

FIG. 7 depicts a non-transitory machine-readable storage medium for measuring polymer melt pool crystallization, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices may include memory resources and processing resources to perform computing tasks. For example, memory resources may include volatile memory (e.g., random access memory (RAM)) and non-volatile memory (e.g., read-only memory (ROM), data storage devices (e.g., hard drives, solid-state devices (SSDs), etc.) to store data and instructions. In some examples, processing resources may include circuitry to execute instructions. Examples of processing resources include a central processing unit (CPU), a graphics processing unit (GPU), or other hardware device that executes instructions, such as an application specific integrated circuit (ASIC).

An electronic device may be a device that includes electronic circuitry. For instance, an electronic device may include integrated circuitry (e.g., transistors, digital logic, semiconductor technology, etc.). Examples of electronic devices include computing devices, workstations, servers, laptop computers, desktop computers, smartphones, tablet devices, wireless communication devices, testing equipment, sensors, additive manufacturing devices, printing devices, smart appliances, robots, etc.

In some examples, electronic devices may be used for determining crystallization information about a polymer melt pool. As used herein, a polymer melt pool includes a polymer substance that is in a liquid state. For example, a polymer powder in a solid state may be heated until it undergoes a phase change to a liquid state. A volume of liquid polymer may be referred to as a polymer melt pool.

As the polymer melt pool cools, the liquid polymer may undergo crystallization as the polymer transitions to a solid state. The polymer phase change may be used in various processes. For example, in additive manufacturing, a polymer powder may be positioned and heated to a liquid state. As the liquid polymer cools to a solid state, a portion of an object may be formed. This process of heating and cooling a polymer may be repeated to form an object.

One example of additive manufacturing includes powder bed fusion (PBF). In PBF the consolidation of powder is selectively facilitated by a beaming heat source. One type of PBF for three-dimensional (3D) printing is Multi Jet Fusion (MJF), which has the capability of high productivity printing by selectively jetting a fusing agent to facilitate the melting of the polymer by an illuminating light. In the PBF process, polymer powder goes through two state-transition processes: from solid to liquid (melting), and liquid to solid (crystallization).

In some examples, quality control is a concern in PBF due to the complexity of the process and the involvement of multi-physics leading to the variation of material properties. Controlling printed material properties may enhance melting quality and reduce defects. In some examples, adjustment of the cooling temperature profile of the polymer melt pool may produce a desired crystallization. Furthermore, the crystallization process impacts the physical properties of a polymer material (e.g., mechanical strength). Therefore, controlling polymer crystallization in PBF is one approach to achieve a desired quality of a printed part. Controlling the crystallization of the polymer may be based on feedback of the crystallization inside the polymer melt pool during the cooling process in the PBF. As described herein, real-time observation of polymer crystallization may be performed. This measured polymer crystallization may be used as feedback to a PBF control process.

Crystallization behavior of the polymer is heavily affected by the cooling profile. Along with crystallinity, spherulite size is a featured parameter during the crystallization of a polymer. In a cooling polymer melt pool, a crystal starts to grow at nucleus sites and become larger over time, which progresses until the polymer has fully crystallized. Furthermore, spherulite size also contributes to mechanical properties of polymer. For example, a larger spherulite may result in a higher yield stress of the polymer.

In some approaches, PBF technologies may employ a cooling process that uses a preset temperature profile of the printing chamber. In these approaches, there is no system to provide information of the crystallization status. To enhance the print quality and material properties of a printed material, examples are described herein to observe the crystallization process and determine crystallization information.

As described above, crystallization of a printed polymer during cooling process in PBF technologies, such as MJF, is not observed in some approaches, despite its role in printing quality. The described examples provide non-contact techniques for observing the crystallization process of a crystalline or semi-crystalline polymer. The described examples may be implemented by analyzing images of a polymer melt pool to characterize optical properties of the solidifying polymer. Information obtained from the images may be utilized to derive crystallization information (e.g., spherulite size, growth rate, and equilibrium time of the crystallization). Therefore, the described examples provide methods for assessing crystal growth via optical characterization. In some examples, spherulite size of the polymer melt pool may be monitored in real-time during the cooling process using optical equipment (e.g., a lighting source and camera).

The present specification describes examples of an electronic device. The electronic device includes a processor and memory storing instructions that cause the processor to receive an image of a polymer melt pool captured during crystallization of the polymer melt pool. The instructions also cause the processor to measure brightness of the polymer melt pool in the captured image. The instructions further cause the processor to determine crystallization information of the polymer melt pool based on the measured brightness of the polymer melt pool.

In another example, the present specification also describes a method that includes capturing an image of a polymer melt pool during crystallization of the polymer melt pool. The method also includes measuring brightness in a plurality of regions of the polymer melt pool in the captured image. The method further includes determining crystallization information for the plurality of regions of the polymer melt pool based on the measured brightness in the plurality of regions of the polymer melt pool.

In yet another example, the present specification also describes a non-transitory computer-readable storage medium comprising instructions executable by a processor to receive a series of images of a polymer melt pool captured during crystallization of the polymer melt pool. The instructions are also executable by the processor to measure brightness of the polymer melt pool in the series of images. The instructions are further executable by the processor to determine crystallization information of the polymer melt pool based on the measured brightness of the polymer melt pool in the series of images.

As used in the present specification and in the appended claims, the term “processor” may be a processor resource, a controller, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile memory (e.g., RAM) and non-volatile memory (e.g., ROM).

As used in the present specification and in the appended claims, the term “data storage device” may include a non-volatile computer-readable storage medium. Examples of the data storage device include hard disk drives, solid-state drives, writable optical memory disks, magnetic disks, among others. The executable instructions may, when executed by the respective component, cause the component to implement the functionality described herein.

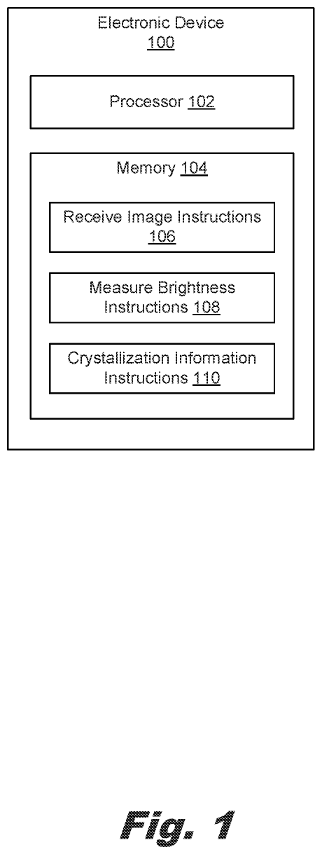

Turning now to the figures, FIG. 1 is a block diagram of an electronic device 100 to measure polymer melt pool crystallization information, according to an example. As used herein, examples of an electronic device 100 may include computing devices, workstations, servers, laptop computers, desktop computers, smartphones, tablet devices, wireless communication devices, testing equipment, sensors, additive manufacturing devices, smart appliances, printing devices, robots, or other devices having memory resources and processing resources.

As described above, the electronic device 100 includes a processor 102. The processor 102 of the electronic device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

In some examples, a memory 104 may be implemented in the electronic device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 100 may also include instructions. The instructions may be implemented in a platform specific language that the processor 102 may decode and execute. The instructions may be stored in the memory 104 during execution. In some examples, the instructions may include receive image instructions 106, measure brightness instructions 108, and crystallization information instructions 110, according to the examples described herein.

As described above, monitoring the crystallization process in PBF technologies may enhance the PBF process. The examples described herein provide for a non-contact, non-destructive technique for studying material properties during the cooling of melted semi-crystalline polymer. Furthermore, the described examples allow for obtaining information of crystal growth status in real-time. Examples of the crystallization information include spherulite size in real-time in powder bed fusion for additive manufacturing of a polymer. Crystallization information may also include the crystal growth rate, which can be monitored as a derivative result. The examples described herein include a measurement system and methods for real-time quantification of the crystal growth of a polymer in the PBF process.

In some examples, a parameter of interest for determining crystallization information includes scattered light, which can be studied via assessing the polymer melt pool brightness. Hence, an approach to determine crystallization information is to characterize the optical properties of the polymer melt pool using optical instruments. For example, the polymer melt pool may be illuminated by a light source and may be observed using an optical camera. In operation, images of the polymer melt pool may be taken during crystallization. The polymer melt pool brightness may be extracted from the captured images using image processing techniques. From the polymer melt pool brightness, the optical properties of the melt pool are analyzed.

Changes in optical properties of the polymer melt pool may be due to the growth of crystallization in the polymer melt pool. Therefore, the crystal status may be correlated to the optical property measured by the described examples. Hence, the specification provides for approaches to study the crystallization of polymer powder. The specification further provides for the study of crystallization kinetics of a polymer (e.g., PA12) and related materials in PBF. Furthermore, examples are described for detecting the time of crystallization when crystal growth reaches equilibrium. The described examples may be used to monitor printing quality of a PBF device by providing feedback on the crystallization quality.

In some examples, the electronic device 100 may be included in stand-alone testing equipment for testing the crystallization process of a polymer. For example, the testing equipment may determine crystallization information for a PBF printing material. In some examples, a polymer powder may be tested using the electronic device 100 before it is used for printing in the PBF device. In other examples, the electronic device 100 may be used to provide feedback for the crystallization of a polymer during the PBF printing process. In some examples, the electronic device 100 may be included in a PBF device.

In some examples, the processor 102 may execute the receive image instructions 106 to cause the processor 102 to receive an image of a polymer melt pool captured during crystallization of the polymer melt pool. Optical properties of the polymer melt pool change during the crystallization process. In term of physics, this is because the solid phase of the polymer in the polymer melt pool scatters a greater amount of incident light than the liquid phase of the polymer. As crystals begin to grow, more incident light is scattered by the solidifying polymer. Therefore, the status of solid crystal growth may be determined by analyzing of the polymer melt pool optical properties, such as transparency and opacity, via the intensity of scattered light of the polymer melt pool.

In some examples, the processor 102 may receive images of the polymer melt pool captured by a camera during the cooling process. In some examples, the polymer melt pool may be illuminated with a light source. In some examples, the light source may include a human-visible light source, infrared light source, an ultraviolet light source, or a combination thereof. The camera may be able to capture images according to the light source used to illuminate the polymer melt pool. For example, the camera may capture images using human-visible light, infrared light, ultraviolet light, etc.

In some examples, the processor 102 may execute the measure brightness instructions 108 to cause the processor 102 to measure brightness of the polymer melt pool in the captured image. For example, the processor 102 may perform image processing to extract the brightness of the polymer melt pool from an image.

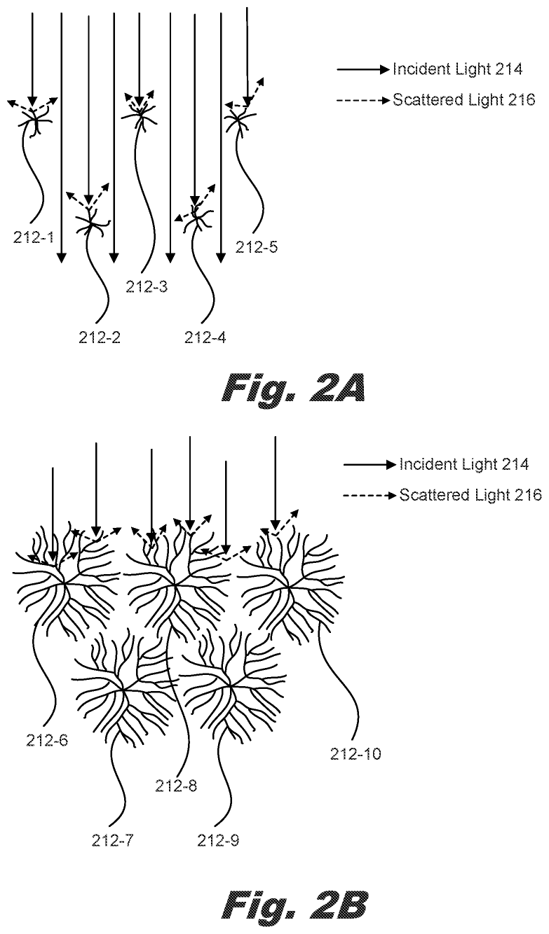

During the cooling of liquid polymer, the transition from a liquid phase to a solid phase (e.g., due to growth of the crystal spherulite) causes a change in the optical property of polymer melt pool. This is due to light scattering at the solid-liquid interface and crystal-amorphous interface. Examples of light scattering in a polymer melt pool are illustrated in FIGS. 2A and 2B.

Referring briefly to FIGS. 2A and 2B, examples of incident light 214 and scattered light 216 in the polymer melt pool are illustrated. In FIG. 2A, nucleation of crystal spherulites (e.g., crystal spherulites 212-1, 212-2, 212-3, 212-4, 212-5) in a polymer melt pool begins as the polymer melt pool cools from a liquid state to a solid state. FIG. 2B represents the polymer melt pool as the crystal spherulites (e.g., crystal spherulites 212-6, 212-7, 212-8, 212-9, 212-10) have grown.

When incident light 214 strikes a crystal spherulite, the amount of scattered light 216 depends on the growth status of the crystal. Therefore, a larger spherulite will scatter more light and result in less transmitted light. The crystal structure may define the light absorbance and transmittance of the polymer, where the more spherulite growth, the more light is scattered by the polymer crystal.

In some examples, the polymer melt pool may be considered as a transparent film containing a spherulite of crystal. Due to the reflection at the crystalline boundaries, a part of light transmitting through the film is scattered and the transmission of light through the film is dependent of spherulite size. In the other words, the optical property of the polymer melt pool is a function of the crystal growth process.

Referring again to FIG. 1, in some examples, optical images of the polymer melt pool may be captured as time progresses under a temperature condition. For example, crystallization of the polymer melt pool may occur under an isothermal temperature condition where the temperature of the polymer melt pool remains approximately constant during the phase change from a liquid phase to a solid phase. In some examples, crystallization of the polymer melt pool may occur under a non-isothermal temperature condition that simulates a cooling condition of the polymer. For example, the cooling condition may be the cooling of the polymer melt pool during printing by a PBF device.

It can be observed that the polymer melt pool appears to be darker during crystallization. In other words, the initial images of the polymer melt pool at the beginning of crystallization appear brighter than images of the polymer melt pool as crystallization progresses. As a result, the average brightness of the polymer melt pool reduces by time. This observation indicates that the polymer melt pool optical characteristics vary during the crystallization process, and are linked to the growth of crystal spherulite. Therefore, the instructions 108 to measure brightness of the polymer melt pool may include executable instructions that when executed cause the processor 102 to average pixel brightness values for a region of the polymer melt pool in a captured image.

In some examples, the processor 102 may execute the crystallization information instructions 110 to cause the processor 102 to determine crystallization information of the polymer melt pool based on the measured brightness of the polymer melt pool. Measuring optical properties during the crystallization of the polymer melt pool may provide information of the crystal growth status, such as spherulite size and growth rate. Brightness of the polymer melt pool may be measured to quantify the crystallization information. In some examples, brightness may be caused by the remaining light from the light source after entering an upper surface of the polymer melt pool and bouncing off a lower surface of the polymer melt pool. In some examples, the lower surface may be the surface of the heater, or a lower surface of an object being manufactured in a PBF process.

In some examples, the crystallization information includes one of a spherulite size of the polymer melt pool, a crystallization growth rate, a time to reach equilibrium of the crystallization of the polymer melt pool, or a combination thereof.

Regarding spherulite size, the polymer melt pool brightness may be extracted from the optical image of the melt pool by calculating the average value of all pixels in a studied region of the polymer melt pool. Because polymer melt pool brightness is an arbitrary unit that is strongly impacted by the observation conditions, polymer melt pool brightness may be converted to spherulite size, which employs length as a physical unit. In some examples, the average spherulite size may be estimated from the polymer melt pool brightness value by comparing it with a standardized set of data on the same setup conditions. As used herein, setup conditions include light source, temperature conditions, polymer melt pool thickness and reflectivity of a lower surface of the polymer melt pool.

To map the melt pool brightness to crystal growth status, an equilibrium status of crystal growth may be used for calibration. Because crystallization is a dynamic process, simultaneous observation of the melt pool brightness and a microscopic crystal image is difficult. However, the brightness of the polymer melt pool at an equilibrium state when crystallization of the polymer melt pool has finished may be used to map the spherulite size to polymer melt pool brightness.

It should be noted that the brightness of the melt pool will reach a stable value when the crystallization completes due to the completion of polymer spherulite growth. This equilibrium state may be employed to map the brightness value with the size of spherulite because the sample can be taken out for a precise measurement of the form and structure of the polymer crystallization using an optical microscope.

In some examples, to collect the standardized data, a given cooling condition may be employed to prepare the standard spherulite size data according to a specific setup. After crystallization of the polymer has been completed, the polymer sample may be observed under an optical microscope to find highlighted features of the spherulites, such as branches and boundaries between spherulites. An image taken from the microscope may be analyzed to find a calibrated average spherulite size (d_{crystal}) for the polymer melt pool at the crystallization equilibrium state, such as by measuring the distance between the centers of the two nearby spherulites. In some examples, this process could be automatically implemented by an image processing code to detect the core of spherulites and measure the distance between them. The brightness (lₛₑₜₜₗₑ) of the polymer melt pool at equilibrium may be measured and recorded as the calibrated equilibrium brightness for the polymer melt pool at a crystallization equilibrium state. At the end of this calibration process, a data pair of the melt pool brightness value (lₛₑₜₜₗₑ) and the spherulite size (d_{crystal}) is obtained.

Once the value of the calibrated average spherulite size at equilibrium (d_{crystal}) is determined along with the melt pool brightness at equilibrium (lₛₑₜₜₗₑ), these values may be used for estimating the average spherulite size with any measured melt pool brightness using an interpolation. In some examples, an initial polymer melt pool brightness (lᵢₙᵢₜᵢₐₗ) may be measured at the beginning of the analysis when the polymer is still in the liquid state. The conversion from a transitioning melt pool brightness to spherulite size may be determined according to Equation 1:

$${d}_{measure} = \frac{\vert {l}_{initial} - {l}_{measure} \vert}{\vert {l}_{initial} - {l}_{settle} \vert} \times {d}_{crystal} \qquad ( 1 )$$

In Equation 1, dₘₑₐₛᵤᵣₑ is the estimated average spherulite size during the analysis, lₛₑₜₜₗₑ is the average polymer melt pool brightness measured at the end of the analysis, lᵢₙᵢₜᵢₐₗ is the average melt pool brightness measured at the beginning of the analysis, and lₘₑₐₛᵤᵣₑ is the melt pool brightness measured during the analysis. It should be noted that this interpolation formula is for one set of melt pool brightness and average spherulite size. More sets of data may be collected by using different temperature conditions for crystallization. Furthermore, in some examples, the interpolation formula may be amended to a higher-order interpolation to increase the precision of the estimation.

With regard to growth rate, in some examples, the growth rate at a given time may be determined as the derivative of average spherulite size by time. It could be calculated using Equation 2:

$$Growth rate = \frac{Δ {d}_{meas ure}}{Δ t} \qquad ( 2 )$$

Equilibrium is the state of which the melt pool brightness becomes stable. This is evidence that the crystallization process has completed because there is no further change in spherulite size when it reaches a maximum size. Therefore, the time to equilibrium may be found as the time when the growth rate reaches zero, as illustrated by Equation 3.

Growth rate≈0→time=time to equilibrium (3)

It should be noted that the equilibrium time is independent of the absolute value of the spherulite size. Therefore, equilibrium time may also be found by determining the time when there is no change in melt pool brightness, as illustrated by Equation 4.

$$\frac{Δ {l}_{meas ure}}{Δ t} \approx 0 \to time = time to equilibrium \qquad ( 4 )$$

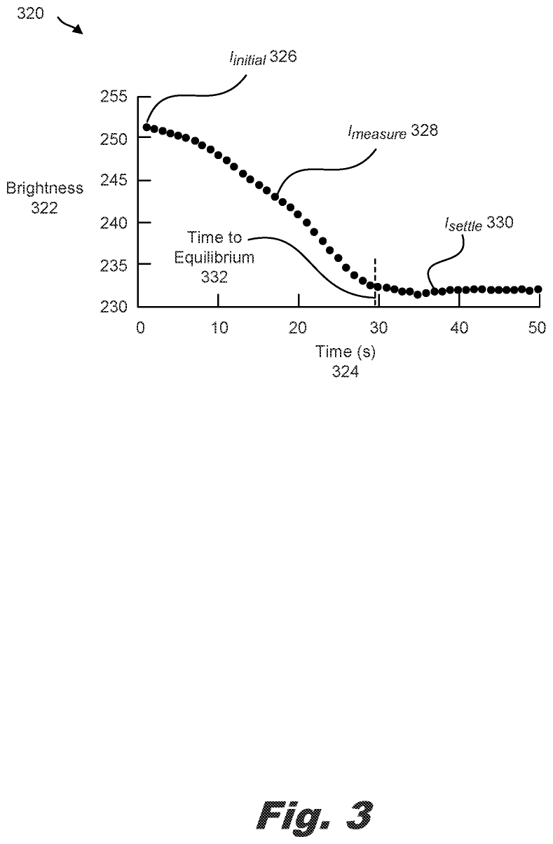

An example of the time to equilibrium of the crystallization process is shown in FIG. 3. Referring briefly to FIG. 3, a graph 320 of measured pixel brightness 322 in an image is plotted over time 324 (in seconds). At the start of analysis, an lᵢₙᵢₜᵢₐₗ 326 is measured. Over the course of the analysis, multiple images are captured and the melt pool brightness (lₘₑₐₛᵤᵣₑ) 328 may be measured for each image. In this example, the brightness (lₛₑₜₜₗₑ) 330 of the polymer melt pool at equilibrium is observed when the measured brightness does not change over a period of time. In other words, equilibrium brightness (lₛₑₜₜₗₑ) 330 remains approximately the same. The time to equilibrium 332 may be determined when there is approximately no change in melt pool brightness.

Returning again to FIG. 1, in some examples, the processor 102 may determine a temperature condition during the crystallization of the polymer melt pool. The processor 102 may determine the crystallization information based on the temperature condition and the measured brightness. For example, calibrated values (e.g., initial brightness, equilibrium brightness, average spherulite size at equilibrium) may be stored for a given temperature condition that the polymer melt pool is subjected to during crystallization. In some examples, multiple calibrated values may be stored for different temperature conditions. The processor 102 may determine which temperature condition applies during an observed crystallization of the polymer melt pool. The processor 102 may then use corresponding calibrated values for the given temperature condition to determine calibration information based on the measured brightness of a polymer melt pool image.

As described above, the electronic device 100 may be a PBF device in some examples. In this case, the processor 102 may adjust a temperature setting of the PBF device based on the crystallization information. For example, the processor 102 may instruct the PBF device to adjust the cooling profile of the polymer melt pool to achieve a crystallization target (e.g., spherulite size, growth rate, equilibrium time of the crystallization). The crystallization target may impact the mechanical properties of the solidified polymer. Therefore, the processor 102 may use the crystallization information to ensure mechanical properties of a PBF-printed object. This feedback may be used to provide quality control for multiple batches of PBF-printed objects.

Because polymer crystallization plays a role in both the material development stage and printing quality control, the described examples may be used in a PBF device to adjust 3D printing with the capability to track the crystallization of polymer melt pool. With non-contact measurements and a standardized setup, the described examples may be employed in developing and testing of material for a PBF device, such as studying crystallization process of a material in development.

Furthermore, knowing the crystallization status provides a better chance to achieve given properties of a printed part. Thus, by obtaining crystallization information, a developer of a PBF system gains the capability of monitoring crystallization. Therefore, the described examples may provide for adjustment of thermal control to the PBF system during crystallization. Hence, the quality control of printing between different batches may be enhanced.

It should be noted that the brightness of the polymer melt pool may be measured through equilibrium after the crystallization has completed. In this case, the spherulite growth has reached maximum size in melt pool. Therefore, the polymer melt pool brightness at equilibrium may be used as a marker for the completion of crystallization.

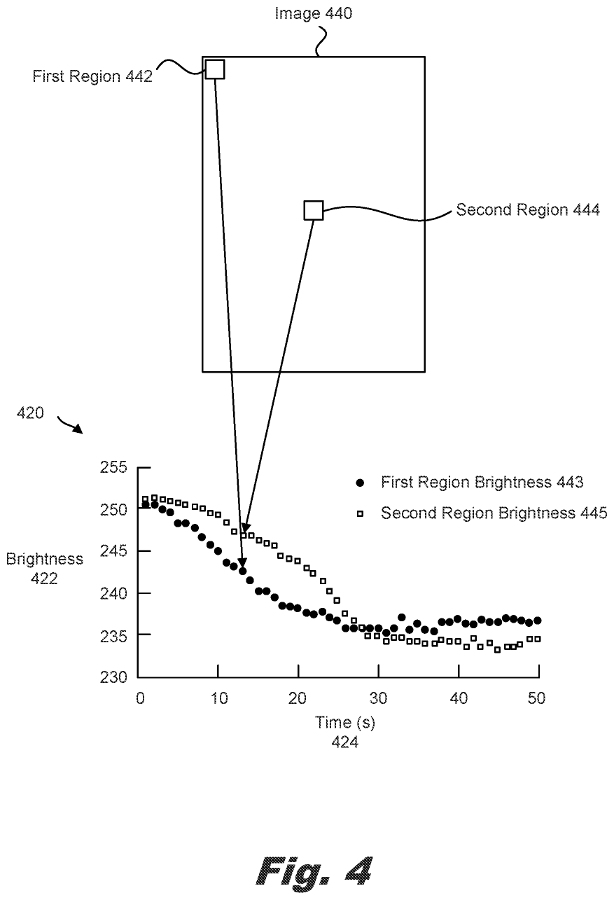

Furthermore, localized crystallization in different sections of a printing chamber may also be analyzed by measuring melt pool brightness in different regions of the polymer melt pool. The variation in polymer melt pool brightness may be employed to monitor the difference of crystallization of different regions in the chamber. An example of this approach is described in FIG. 4.

FIG. 4 illustrates an example of determining crystallization information for a plurality of regions of a polymer melt pool. One aspect of PBF printing is that the melting area may be a large size. Hence, there may be variation of the temperature profile at different positions of the polymer melt pool during the cooling process. For example, the outer region of the polymer melt pool may cool faster compared with the center region due to higher heat convection at the boundary. Therefore, crystallization behavior will also be different at these regions. For example, crystallization may finish faster at boundaries, but the boundaries may have a smaller spherulite size due to a faster cooling profile.

This phenomenon may be observed and measured as illustrated in FIG. 4, which depicts the analysis of the brightness transition at different locations in the polymer melt pool. In this example, an image 440 is obtained of the polymer melt pool at a given time 424. For example, a camera may capture the image 440 at some point during crystallization of the polymer melt pool.

A plurality of regions in the image 440 may be identified. For example, a first region 442 and a second region 444 may be identified. The plurality of regions may include multiple disconnected regions inside polymer melt pool. For example, the first region 442 may be physically separated from the second region 444. For example, the first region 442 may be a corner or other boundary of the polymer melt pool. The second region 444 may be a center region of the polymer melt pool.

A processor may measure the brightness in the plurality of regions of the polymer melt pool. This may be accomplished as described in FIG. 3. In the captured image a graph 420, the brightness 443 of the first region 442 and the brightness 445 of the second region 444 are shown over time 424. In this example, the first region brightness 443 is depicted as circles and second region brightness 445 is depicted with squares.

The results show that the brightness 422 at the boundary (i.e., the first region 442) reduces faster and reaches a higher value at equilibrium, as compared to the center region (i.e., the second region 444). This observation can be interpreted as faster completion of crystal growth, and a smaller average size of spherulites at the boundary as compared to the center.

It should be noted that a PBF-printed object may not have uniform crystallization due to the variation of the temperature profile along the object. Hence, the capability of simultaneous analysis at multiple locations may provide useful insight into the crystallization behavior of polymer melting in a large area. By allowing for the visualization of relative degrees of crystallization at different locations in the polymer melt pool, simultaneous crystallization analysis at multiple locations may be helpful in determining crystallization distribution and predicting mechanical properties of the object.

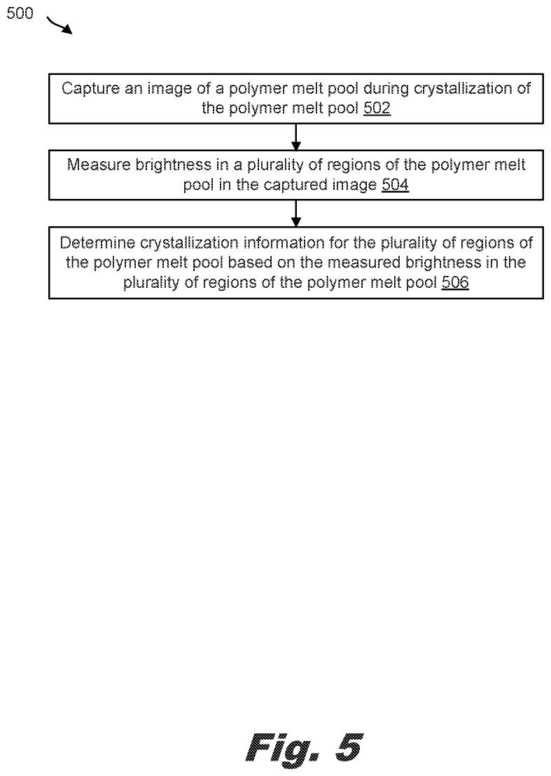

FIG. 5 is a flow diagram illustrating a method 500 for measuring polymer melt pool crystallization, according to an example. In some examples, the method 500 may be performed by a processor, such as the processor 102 of FIG. 1.

At 502, an image of a polymer melt pool may be captured during crystallization of the polymer melt pool. For example, the polymer melt pool may be illuminated with a light source. In some examples, the light source may include one of a visible light source, an infrared light source, or an ultraviolet light source. A camera may capture multiple images of the polymer melt pool over a period of time. In some examples, the processor may start a timer. While the timer is running, the camera may continue to capture the polymer melt pool. At the beginning of the period of time, the polymer melt pool may be in a liquid state. Over the period of time, the polymer melt pool may cool such that the polymer changes to a solid state. The camera may provide the image or a series of images of the polymer melt pool to the processor.

At 504, brightness may be measured in a plurality of regions of the polymer melt pool in the captured image. For example, the plurality of regions may include multiple disconnected regions inside the polymer melt pool. The processor may determine average pixel brightness values for each of the regions in the image. For example, the processor may determine a first brightness value by averaging the pixel brightness in a first region, the processor may determine a second brightness value by averaging the pixel brightness in a second region, and so forth.

At 506, crystallization information may be determined for the plurality of regions of the polymer melt pool based on the measured brightness in the plurality of regions of the polymer melt pool. For example, for each region, the processor may use the measured brightness to determine the spherulite size, crystallization growth rate, a time to reach equilibrium, or a combination thereof. This may be accomplished according to Equations 4-7.

In some examples, the processor may use calibration values and the measured brightness to interpolate the crystallization information as described above. For example, the processor may determine a calibrated initial brightness for the polymer melt pool at a melted state. The processor may determine a calibrated equilibrium brightness for the polymer melt pool at a crystallization equilibrium state. The processor may determine a calibrated average spherulite size for the polymer melt pool at the crystallization equilibrium state. In some examples, these calibration values may be stored in memory from an earlier calibration process. The processor may retrieve the calibration values. The processor may then determine an average spherulite size for each of the plurality of regions based on the measured brightness in the plurality of regions, the calibrated initial brightness, the calibrated equilibrium brightness, and the calibrated average spherulite size according to Equation 1.

In some examples, the calibrated initial brightness, the calibrated equilibrium brightness, and the calibrated average spherulite size may be determined for a given temperature profile during the crystallization of the polymer melt pool, for a given light source illuminating the polymer melt pool, for a given thickness of the polymer melt pool and for a given reflectivity of the lower surface of the melt pool. For example, the calibrated initial brightness, the calibrated equilibrium brightness, and the calibrated average spherulite size may be measured under certain conditions. These conditions may include the lighting (e.g., visible, infrared, ultraviolet, etc.), temperature conditions (e.g., an isothermal cooling profile, non-isothermal cooling, etc.), the thickness of the polymer melt pool and the reflectivity of the lower surface of the melt pool. When analyzing the polymer melt pool, the calibration values may be selected to match the actual conditions of the polymer melt pool.

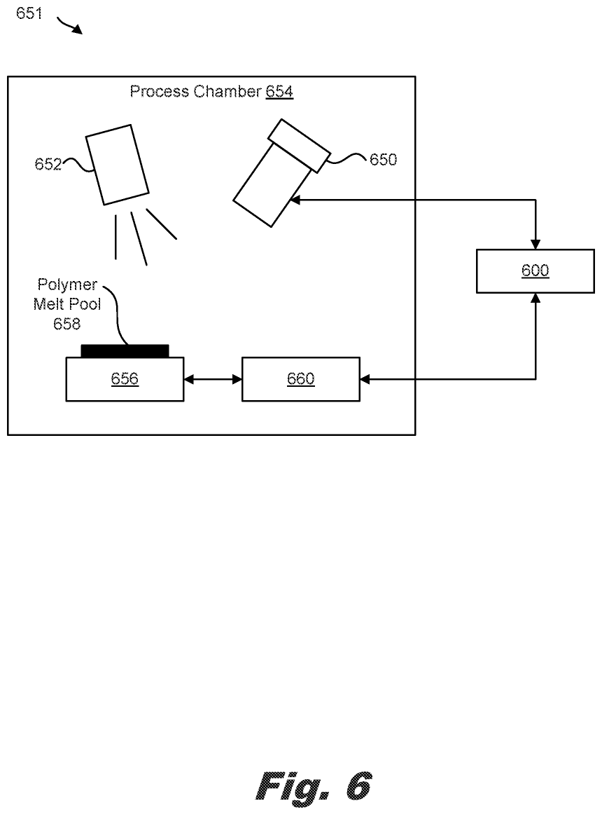

FIG. 6 illustrates a system 651 that may be used to measure crystallization of a polymer melt pool 658, according to an example. In this example, a light source 652 may serve as a photon source. The light source 652 may provide light (e.g., visible, infrared, ultraviolet) with constant intensity for a period of time.

A digital camera 650 may serve as a photon detector. The digital camera 650 may be an image sensor device. In some examples, the camera 650 may be equipped with a lens suitable for taking close-up images of a polymer melt pool 658 during the cooling process.

An electronic device 600 may receive the images captured by the camera 650. The electronic device 600 may include a processor and memory, as described in FIG. 1. The electronic device 600 may determine crystallization information from the measured brightness in the images as described above.

A process chamber 654 may isolate the polymer melt pool 658 from surrounding lighting conditions. Thus, the illumination of the polymer melt pool 658 may be from the light source 652.

A temperature control stage 656 may simulate the melting and crystallization condition of the polymer melt pool 658. The temperature control stage 656 may be used to create temperature conditions to measure the polymer behavior. In some examples, the temperature control stage 656 may be incorporated in a PBF device. For example, the temperature control stage 656 may include an internal heater and lamp for melting and chamber cooling. The surface of the temperature control stage 656 may bounce off striking light, which is being captured by the camera 650.

In some examples, the polymer melt pool 658 may be the topmost layer of the BPF printing process or the melt pool generated by the temperature control stage 656 to simulate the phase transition of the polymer material. The electronic device 600 may implement image processing and calculations to obtain the output data (e.g., spherulite size, growth rate, time to equilibrium).

The system 651 may also include a controller and temperature sensing device 660 for controlling the temperature of the temperature control stage 656. The controller and temperature sensing device 660 may send data (e.g., temperature settings) to the electronic device 600.

In some examples, a polymer powder (e.g., PA12) may be spread on the temperature control stage 656. The polymer powder may be heated to a melting state following a given temperature condition (e.g., simulated or actual PBF melting conditions). Cooling control may be applied by the controller and temperature sensing device 660 to simulate the cooling temperature profile of the PBF process.

During cooling, the polymer melt pool 658 may be illuminated by the light source 652 and the camera 650 may continuously capture images of the polymer melt pool 658 with a defined time interval. The images may be provided to the electronic device 600.

The electronic device 600 may calculate the average brightness of the image of the polymer melt pool 658 to quantify the opacity change. Using the extracted brightness information, the electronic device 600 may determine crystallization information for the polymer melt pool 658. The electronic device 600 may use polymer melt pool brightness and calibration values to output spherulite size, growth rate, time to equilibrium, or a combination thereof.

In some examples, the average value of brightness may be calculated by the mean of all pixel values in a selected region of the polymer melt pool 658. Therefore, the electronic device 600 may gather signals from many pixels. Hence, although the resolution of each pixel is low, such as the output value of each pixel is from 0 to 255, the output brightness may have high definition due to the averaging from multiple pixels.

In some examples, the crystallization information may be sent to a display unit for display to a user. In some examples, the crystallization information may be sent to a storing unit (e.g., memory).

In some examples, the electronic device 600 may provide input to the controller 660 for adjustment of the crystallization condition. For example, the electronic device 600 may instruct the 660 to adjust the temperature of the temperature control stage 656 based on the measured crystallization information.

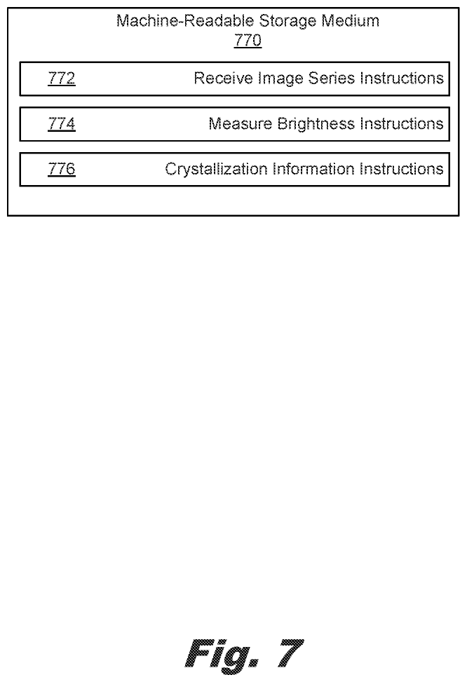

FIG. 7 depicts a non-transitory machine-readable storage medium 770 for measuring polymer melt pool crystallization, according to an example. To achieve its desired functionality, an electronic device includes various hardware components. Specifically, an electronic device includes a processor and a machine-readable storage medium 770. The machine-readable storage medium 770 is communicatively coupled to the processor. The machine-readable storage medium 770 includes a number of instructions 772, 774, 776 for performing a designated function. The machine-readable storage medium 770 causes the processor to execute the designated function of the instructions 772, 774, 776. The machine-readable storage medium 770 can store data, programs, instructions, or any other machine-readable data that can be utilized to operate the electronic device 100. Machine-readable storage medium 770 can store computer readable instructions that the processor of the electronic device 100 can process or execute. The machine-readable storage medium 770 can be an electronic, magnetic, optical, or other physical storage device that contains or stores executable instructions. Machine-readable storage medium 770 may be, for example, Random Access Memory (RAM), an Electrically Erasable Programmable Read-Only Memory (EEPROM), a storage device, an optical disc, etc. The machine-readable storage medium 770 may be a non-transitory machine-readable storage medium 770, where the term “non-transitory” does not encompass transitory propagating signals.

Referring to FIG. 7, receive image series instructions 772, when executed by the processor, may cause the processor to receive a series of images of a polymer melt pool captured during crystallization of the polymer melt pool. Measure brightness instructions 774, when executed by the processor, may cause the processor to measure brightness of the polymer melt pool in the series of images. Crystallization information instructions 776 when executed by the processor, may cause the processor to determine crystallization information of the polymer melt pool based on the measured brightness of the polymer melt pool in the series of images.

In some examples, the crystallization information instructions 776 may include instructions that when executed by the processor, may cause the processor to determine an average spherulite size of the polymer melt pool for each image in the series of images based on the measured brightness of the polymer melt pool in the series of images. In other words, the processor may determine the average spherulite size of the polymer melt pool over the series of images. This may be accomplished according to Equation 1.

In some examples, the crystallization information instructions 776 may include instructions that when executed by the processor, may cause the processor to determine a crystallization growth rate based on a change in the average spherulite size over a period of time. The crystallization growth rate may be determined according to Equation 2.

In some examples, the crystallization information instructions 776 may include instructions that when executed by the processor, may cause the processor to determine an equilibrium time. In some examples, the equilibrium time may be determined based on a change in crystallization growth rate, as described in Equation 3. In some examples, the equilibrium time may be determined based on a change in the measured brightness of the polymer melt pool over a period of time, as described in Equation 4.

1. An electronic device, comprising:
a processor; and
a memory communicatively coupled to the processor and storing executable instructions that when executed cause the processor to:
receive an image of a polymer melt pool captured during crystallization of the polymer melt pool;
measure brightness of the polymer melt pool in the captured image; and
determine mechanical strength of the polymer melt pool based on the measured brightness of the polymer melt pool.

2. The electronic device of claim 1, wherein the instructions to measure brightness of the polymer melt pool comprise executable instructions that when executed cause the processor to:
average pixel brightness values for a region of the polymer melt pool in the captured image.

3. The electronic device of claim 1, wherein determining mechanical strength comprises determining crystallization information of the polymer melt pool, the crystallization information comprises one of a spherulite size of the polymer melt pool, a crystallization growth rate, and a time to reach equilibrium of the crystallization of the polymer melt pool.

4. The electronic device of claim 1, wherein crystallization of the polymer melt pool occurs under: an isothermal temperature condition; or a non-isothermal temperature condition that simulates a cooling condition of the polymer.

5. The electronic device of claim 1, wherein the instructions to determine mechanical strength comprise executable instructions that when executed cause the processor to:
determine a temperature condition during the crystallization of the polymer melt pool; and determine the mechanical strength based further on the temperature condition and the measured brightness.

6. The electronic device of claim 1, wherein the electronic device comprises a powder bed fusion (PBF) device, and wherein the instructions further comprise executable instructions that when executed cause the processor to:
adjust a temperature setting of the PBF device based on the mechanical strength of the polymer melt pool.

7. A method, comprising:
capturing an image of a polymer melt pool during crystallization of the polymer melt pool;
measuring brightness in a plurality of regions of the polymer melt pool in the captured image; and
determining mechanical strength for the plurality of regions of the polymer melt pool based on the measured brightness in the plurality of regions of the polymer melt pool.

8. The method of claim 7, wherein the plurality of regions comprises multiple disconnected regions inside the polymer melt pool.

9. The method of claim 7, further comprising illuminating the polymer melt pool with a light source, wherein the light source comprises one of a visible light source, an infrared light source, and an ultraviolet light source.

10. The method of claim 7, further comprising:
determining a calibrated initial brightness for the polymer melt pool at a melted state;
determining a calibrated equilibrium brightness for the polymer melt pool at a crystallization equilibrium state;
determining a calibrated average spherulite size for the polymer melt pool at the crystallization equilibrium state; and
determining an average spherulite size for each of the plurality of regions based on the measured brightness in the plurality of regions, the calibrated initial brightness, the calibrated equilibrium brightness, and the calibrated average spherulite size.

11. The method of claim 7, wherein the calibrated initial brightness, the calibrated equilibrium brightness, and the calibrated average spherulite size are determined for a given temperature profile during the crystallization of the polymer melt pool, a given light source illuminating the polymer melt pool, a given thickness of the polymer melt pool, and reflectivity of a lower surface of the polymer melt pool.

12. A non-transitory computer-readable storage medium comprising instructions executable by a processor to:
receive a series of images of a polymer melt pool captured during crystallization of the polymer melt pool;
measure brightness of the polymer melt pool in the series of images; and
determine mechanical strength of the polymer melt pool based on the measured brightness of the polymer melt pool in the series of images.

13. The non-transitory computer-readable storage medium of claim 12, wherein the instructions to determine mechanical strength comprise instructions executable by the processor to:
determine an average spherulite size of the polymer melt pool for each image in the series of images based on the measured brightness of the polymer melt pool in the series of images.

14. The non-transitory computer-readable storage medium of claim 13, wherein the instructions to determine mechanical strength comprise instructions executable by the processor to:
determine a crystallization growth rate based on a change in the average spherulite size over a period of time.

15. The non-transitory computer-readable storage medium of claim 12, wherein the instructions to determine mechanical strength comprise instructions executable by the processor to:
determine an equilibrium time: based on a change in crystallization growth rate; or based on a change in the measured brightness of the polymer melt pool over a period of time.
